(19) United States
(12) Patent Application Publication
(10) Pub. No.: US 2025/0182032 A1
(43) Pub. Date: Jun. 5, 2025

(54) METHODS AND SYSTEMS TO GENERATE THE PROCESS MODEL OF PLANT PROCEDURES

(71) Applicant: INJE UNIVERSITY INDUSTRY-ACADEMIC COOPERATION FOUNDATION, Gimhae-si, Gyeongsangnam-do (KR)

(72) Inventors: Yongsun CHOI, Yeonje-gu, Busan (KR); Minh Duc NGUYEN, Gimhae-si, Gyeongsangnam-do (KR)

(21) Appl. No.: 17/997,638

(22) PCT Filed: Dec. 1, 2021
(86) PCT No.: PCT/KR2021/018004

§ 371 Date: Feb. 4, 2025

(30) Foreign Application Priority Data
May 4, 2021 (KR) 10-2021-0057841

(51) Int. Cl. G06Q 10/067; G06Q 50/04

(52) U.S. Cl. CPC G06Q 10/067; G06Q 50/04

(57) ABSTRACT

The disclosure provides methods and systems to generate Business Process Model and Notation (BPMN) based process models for plant procedures utilizing information extracted from plant procedures via natural language processing. A process model generation system of the disclosure is configured to include an information extraction module that extracts all significant syntactic and semantic information from procedure documents and a process model generation module that generates process models of the procedures utilizing the syntactic and semantic information extracted by the information extraction module. The process model generation module includes a conversion unit that represents each paragraph of procedures into one or more BPMN elements and their properties utilizing the syntactic and semantic information extracted from procedures and a generation unit that generates the final BPMN-based process models of procedures by integrating and reconstructing the instantiated BPMN elements.

### TECHNICAL FIELD

The following description relates to plant procedures, more specifically, methods and systems to generate process models of plant procedures to enable all interested parties to intuitively understand the details of procedures and easily conduct further additional analysis of procedures. Utilizing information extracted from plant procedures via natural language processing (NLP) technologies, each paragraph of a procedure is represented into one or more Business Process model and Notation (BPMN) element(s) and their properties, and then the final BPMN-based process model of the procedure is generated through integrating and reconstructing the BPMN elements.

### BACKGROUND ART

A plant described in the present specification refers to an industrial plant operating large facilities, such as a power plant, an oil refinery, a (petro) chemical plant, a desalination plant, etc. The embodiments that are described below have been exemplified with nuclear power plant (NPP) procedures, however, it is apparent that the disclosure could be also applied to procedures of other types of industrial plants.

Procedures play a key role in ensuring safe, deliberate, and controlled operation of a plant equipped with a lot of facilities, such as an NPP, by broadly supporting all the activities of its personnel. They also play an intermediary role in the transfer of knowledge, regarding the design requirements and actual implementation of a plant, from system engineers to the operators of the plant. They even play important roles for training the personnel of a plant. Furthermore, procedures support the plant managers' understanding of how exactly to meet the standards and expectations for the operation and maintenance of the plant.

Thus, procedures are desired be accurate in technical and operational aspects integrating the up-to-date knowledge available in all relevant areas which include the requirements, policies, physical facilities, processes, and people involved to operate the plant safely. In addition, the controlled documents of procedures must be easy to follow to ensure human performance quality by clearly providing the purpose, specific intent, and sequenced directions for each activity, program, or process.

Several modeling approaches have been already proposed for the summary or additional analysis of procedures. For example, flowcharts have been utilized by the systems of ImPRO, SIMPROC, COPMA- [symbol] , etc., and Colored Petri net (CPN) or Multi-level flow modeling (MFM) models have been employed to verify technical aspects of procedures.

However, those procedure models are not easy to understand for various parties operating and managing a plant, and are limited in representing all the details of procedures. Procedure models should be easy to understand for all the parties involved with the development and continuous improvement of procedures. At the same time, rich semantics are required to represent complex processes in all contexts. Furthermore, ease of incorporation with a variety of analytical techniques is also required to enable analysis from different perspectives. Existing approaches of procedure modeling are limited in satisfying all the above-mentioned requirements.

Additionally, existing procedure modeling approaches require extensive manual effort of domain experts in building and validating a large number of procedure models. Moreover, it is not easy to sustain modeling coherency for a large number of procedures.

Those drawbacks have been barriers for building and utilization of intuitive and extensible procedure models.

### DISCLOSURE

### Technical Problem

The objective of the disclosure is to provide a method and a system that automatically generates process models of procedures represented in Business Process Model and Notation (BPMN), which are intuitive, rich in semantics, easy to integrate with various analysis techniques, and extensible. According to the disclosure, each paragraph of plant procedures is represented into one or more BPMN elements and their properties via natural language processing technologies, and then the final BPMN-based process models of procedures are generated through integrating and reconstructing the BPMN elements.

### Solution to Problem

In a general aspect, a method to generate process models of plant procedures in accordance with one or more embodiments of the disclosure is accomplished by sequentially performing an information extraction stage that extracts all significant syntactic and semantic information from procedures; and a process model generation stage that generates process models of procedures utilizing the syntactic and semantic information extracted.

The information extraction stage may include a first stage that preprocesses the input procedure documents; a second stage that applies existing NLP technologies to the text paragraphs returned from the first stage and corrects any misinterpreted NLP results, of POS tags and parse trees of tokens; and a third stage that performs semantic element extraction, paragraph type classification, and action step component identification for each text paragraph of procedures utilizing the results of the first and the second stages.

To detect and correct the misinterpreted NLP results of POS tags and parse trees of tokens at the second stage, pattern-based built-in rules integrated with a lexical database are utilized.

The semantic element extraction at the third stage may be performed in combined manner, by looking up instances of words included in a predefined ontology each associated with a semantic type; and by pattern-based built-in rules described with POS tags, syntactic tags and elements, pre-found semantic tags and elements, and the resulting semantic types.

The paragraph type classification at the third stage identifies each paragraph into one of predefined types classified into three groups, a first group of action step types each including two components of action verb(s) and target object(s), a second group of types each relatively more relevant to an action step than the types belong to a third group, and a third group of types each relatively less relevant to an action step than the types belong to a second group.

The step component identification at the third stage detects multiple optional components for each paragraph of an action step type, other than two components of action verb(s) and target object(s), utilizing POS tags, semantic element tags, and parse tree tags according to hierarchical structuring of tokens.

The process model generation stage may include a sub-stage of representing each paragraph of the procedures into one or more BPMN elements and their properties utilizing the syntactic and semantic information extracted; and another sub-stage of generating final BPMN-based process models of procedures by integrating and reconstructing the BPMN elements.

For each paragraph classified into the first group of action step types, the paragraph itself or its action clause may be represented into individual BPMN element(s) of activities, events or sequence flows, where its condition clause (if exist) may be represented into individual BPMN element(s) of gateways or events. For each paragraph classified into the second or the third group may be represented into BPMN element(s) that is associated or attached to the individual BPMN element(s) instantiated for a paragraph classified into the first group of action step types.

The individual BPMN elements instantiated for paragraphs of action step types are integrated by connecting each pair of them with a sequence flow based on their precedence, split, or referencing relation; and then the integrated BPMN-based process models of procedures are reconstructed by decomposing or combining the BPMN elements.

A system of the disclosure to generate process models of plant procedures is configured to include an information extraction module that extracts all significant syntactic and semantic information from procedures; and a process model generation module that generates process models of procedures utilizing the syntactic and semantic information extracted by the information extraction module.

The information extraction module may include the following units: a preprocessing unit comprising a non-text processing unit that separates out images and tables in input procedure documents and a text processing unit that extracts structural properties and rich text features for each text paragraph of input procedure documents; an extended natural language processing (NLP) unit that applies existing NLP technologies utilizing public NLP tools for each text paragraph returned from the preprocessing unit and corrects any misinterpreted NLP results; and an information extraction unit that extracts all significant syntactic and semantic information, which includes semantic elements, paragraph types, and step components, for each text paragraph utilizing preprocessing and extended NLP results.

The extended NLP unit may include the following three subunits: a first NLP unit for tokenization, sentence splitting, and lemmatization; a second NLP unit for part-of-speech (POS) tagging for each token and hierarchical structuring of tokens for each sentence; and a third NLP unit that detects and corrects any misinterpreted NLP results from the outputs of the second NLP unit, utilizing pattern-based built-in rules integrated with a lexical database.

The information extraction unit may include the following three subunits: a semantic element extraction unit that identifies any significant word(s) of token(s) each to be tagged with one of predefined types utilizing ontology lookup and pattern-based built-in rules; a paragraph type classification unit that identifies each paragraph into one of predefined paragraph types classified into three groups, a first group of action step types each including two components of action verb(s) and target object(s), a second group of types each relatively more relevant to an action step than the types belong to a third group, and a third group of types each relatively less relevant to an action step than the types belong to a second group; and a step component identification unit that detects multiple optional components for each paragraph of an action step type, other than two components of action verb(s) and target object(s), utilizing POS tags, semantic element tags, and parse tree tags according to hierarchical structuring of tokens.

The process model generation module may include a conversion unit that represents each paragraph of the procedures into one or more BPMN elements and their properties utilizing the syntactic and semantic information extracted; and a generation unit that provides final BPMN-based process models of procedures by integrating and reconstructing the BPMN elements.

The conversion unit may represent some of procedure paragraphs into individual BPMN elements of flow objects or sequence flows, where the rest of procedure paragraphs are represented into BPMN elements that are associated or attached to the individual BPMN elements.

The generation unit may integrate individual BPMN elements, instantiated for procedure paragraphs, by connecting each pair of them with a sequence flow based on their precedence, split, or referencing relation; and then may reconstruct the integrated BPMN process models of procedures by decomposing or combining the BPMN elements.

### Effects of Invention

According to the disclosure, a BPMN-based process model that represents the details of a procedure intuitively may be generated in automatic and coherent manner utilizing the NLP-based information extraction results.

According to the disclosure, all interested parties may understand the details of procedures intuitively, with all significant syntactic and semantic information extracted from procedures are represented into BPMN elements and their properties of rich semantics.

According to the disclosure, inter-procedure relations for a large number of procedures may be analyzed comprehensively utilizing the automatically generated process models of procedures.

According to the disclosure, an integrated procedure management system may be upgraded, including continuous improvement of procedures, owing to being capable to identify where to improve in an individual procedure or among multiple procedures utilizing various comprehensive analysis results of process models of procedures that are intuitively understandable for all interested parties.

### BRIEF DESCRIPTION OF DRAWINGS

FIG. 1 describes the core elements of BPMN applied in the disclosure.

FIG. 2 is a block diagram of a system generating process models of plant procedures in accordance with one or more embodiments of the disclosure.

FIG. 3 is a block diagram of the information extraction module in FIG. 2.

FIGS. 4 to 19 illustrate representations of procedure paragraphs into BPMN element(s) according to their paragraph types.

FIG. 20 shows a BPMN meta-model extended to represent all significant details of procedures according to the disclosure.

FIGS. 21 to 25 illustrate the reconstruction of the BPMN-based process models of procedures, after all individual BPMN elements instantiated for procedure paragraphs are integrated by connecting each pair of them with sequence flows, to make it more concise and intuitive by decomposing or combining the BPMN elements.

FIGS. 26 to 29 illustrate BPMN diagrams representing the process model of a hypothetical NPP procedure and its example analysis results according to the disclosure.

FIG. 30 illustrates referencing relations found, according to the disclosure, from 25 procedures of a commercial NPP in United States.

### BEST MODE FOR CARRYING OUT THE INVENTION

The advantages and features of the disclosure, and the manner of achieving them will be apparent from and elucidated with reference to the embodiments described hereinafter in conjunction with the attached drawings. Hereinafter, a detailed description of known functions and configurations incorporated herein will be omitted when it may make the subject matter of the disclosure unclear.

The following terms are defined in consideration of the functions of the disclosure, and these may be changed according to the intention of the user or operator.

The disclosure may, however, be embodied in many different forms and should not be construed as being limited to the embodiments set forth herein. Rather, these embodiments are provided so that this disclosure will be thorough and complete, and will fully convey the scope of the invention to those skilled in the art. The invention is only defined by the scope of the claims. Therefore, the definition should be based on the contents throughout this specification.

A detailed description of the disclosure will be given below with attached drawings.

Process model representation applied in the disclosure is based on Business Process Model and Notation (BPMN) that is maintained by the Object Management Group (OMG). BPMN is a standard graphical notation aimed to represent complex business processes intuitively. BPMN represents a process in a diagram like a flow chart or a UML activity diagram. Additionally, the details of each diagram element may be represented with its properties.

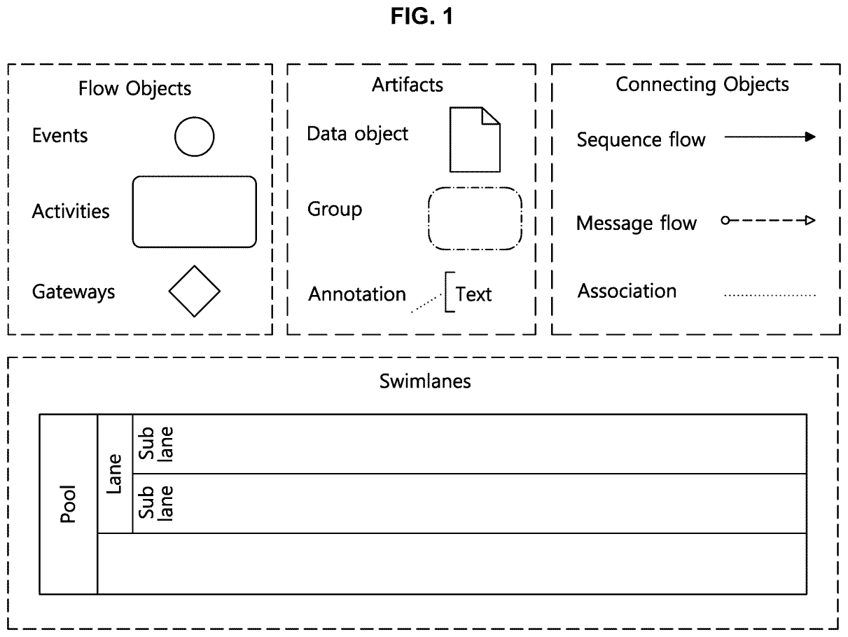

As shown in FIG. 1, the BPMN meta-model includes elements classified into four categories: flow objects, artifacts, connecting objects, and swimlanes.

Flow objects include elements of activities, events, and gateways that define the behavior of a process. An activity, represented by a rounded rectangle, defines a unit of work to be performed, as a task or as a subprocess of one or more tasks. A task can be performed by human or by plant equipment. A subprocess is distinguished from a task with a small square, marked inside with a cross (+), on the bottom boundary line. An event, represented by a circle, is something that ‘happens’ during the execution of a process like a specific status of plant equipment. Events exist in three categories, each with a distinct border style: start (thin border), intermediate (double border), and end (thick border), where each of their usage is additionally designated by the enclosed marker. A gateway is used to control divergence (with a split) and convergence (with a join) of sequence flow(s), where its control type is compatible with one of the logical operators, such as exclusive (XOR), inclusive (OR), parallel (AND), or their complex combinations.

Artifacts have no effect on the process flow and include the followings: A data object is used to represent any type of information associated with an activity; A group is used to informally represent multiple elements of a process; An annotation is used to provide additional information about a process.

A connecting object depicts how a flow object is connected with another flow object or an artifact. A sequence flow indicates the precedence order for a pair of flow objects. A message flow indicates an exchange of messages between a pair of flow objects. An association connects relevant information, of a data object or an annotation, to a flow object.

A swimlane consists of a pool and at least one lane inside. A pool is used to represent a process and contains other categories of BPMN elements connected each other. A lane is a partition within a pool designated for each distinct process participant and contains BPMN elements to be executed by that participant.

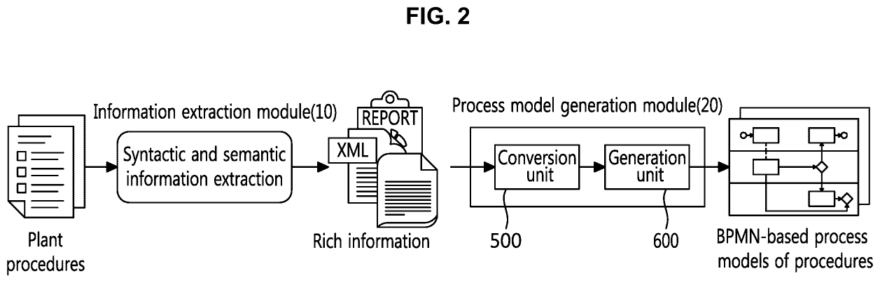

FIG. 2 is a block diagram of a system that generates process models of plant procedures in accordance with one or more embodiments of the disclosure.

As depicted in FIG. 2, a system that generates process models of procedures may represent each paragraph of procedures into BPMN elements and their properties, utilizing the NLP-based information extraction results. After that, the system may generate BPMN-based process models of procedures by integrating the instantiated BPMN elements and then reconstructing them. The system may include an information extraction module 10 that extracts all significant syntactic and semantic information from procedure documents and a process model generation module 20 that generates process models of procedures utilizing syntactic and semantic information extracted by the information extraction module 10.

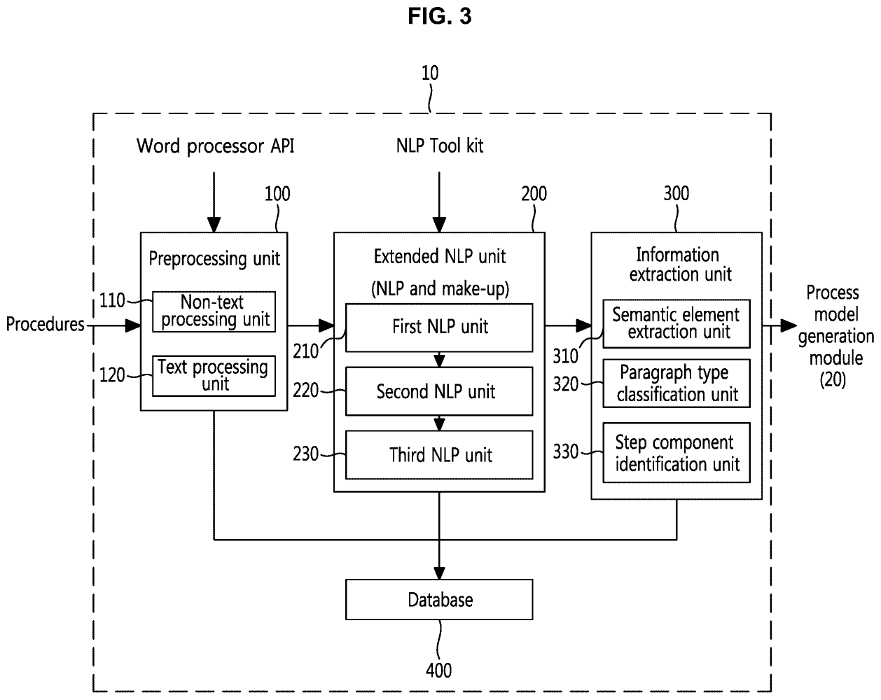

FIG. 3 is a block diagram of an information extraction module in FIG. 2. The information extraction module 10 may automatically extract all significant syntactic and semantic information from procedure documents. The disclosure may represent all those significant information of procedures into process models with rich semantics.

The information extraction module 10 may include a preprocessing unit 100 that extracts structural properties and rich text features for each text paragraph of input procedure documents utilizing word processor APIs; an extended NLP unit 200 that applies NLP technologies utilizing public NLP tools for each text paragraph returned from the preprocessing unit 100 and corrects any misinterpreted NLP results; and an information extraction unit 300 that identifies all significant semantic elements each to be tagged with one of predefined semantic types, classifies each paragraph into one of predefined paragraph types, and detects multiple optional components for each paragraph of an action step type.

The preprocessing unit 100 may include a non-text processing unit 110 (Non-Text object Handling) and a text processing unit 120 (Create and fill-in text feature for ‘Paragraph’ instances).

The extended NLP unit 200 is a customized NLP tool that applies existing NLP technologies utilizing public NLP tools for each text paragraph, including text paragraphs contained in tables, returned from the preprocessing unit 100 and corrects any misinterpreted NLP results. The extended NLP unit 200 may include the following three subunits: a first NLP unit 210 that performs tokenization, sentence splitting, and lemmatization; a second NLP unit 220 that performs part-of-speech (POS) tagging for each token and hierarchical structuring of tokens for each sentence; and a third NLP unit 230 that detects and corrects any misinterpreted NLP results of the second NLP unit 220, utilizing pattern-based built-in rules integrated with a lexical database. They are performed in the order of the first NLP unit 210, the second NLP unit 220, and the third NLP unit 230. Two types of hierarchical structuring of tokens are provided as parse trees, constituency-based and dependency-based.

The information extraction unit 300 may include the following three subunits: a semantic element extraction unit (SE) 310 identifies all significant word(s) of token(s), each to be tagged with one of predefined semantic types, utilizing ontology lookup and pattern-based built-in rules; a paragraph type classification unit (PC) 320 classifies each paragraph into one of predefined paragraph types; and, a step component identification unit (CI) 330 detects multiple optional components for each paragraph of an action step type, other than two components of action verb(s) and target object(s).

The semantic element extraction unit (SE) 310 identifies all significant word(s) of token(s), each to be tagged with one of predefined semantic types. Semantic element extraction is performed in combined manner, by looking up instances of words included in a predefined ontology each associated with a semantic type; and by pattern-based built-in rules described with POS tags, syntactic tags and elements, pre-found semantic tags and elements, and the resulting semantic types.

Semantic types included in an ontology may be composed of the concepts that could possibly answer the 3 questions associated with action steps, as shown in [Table 1].

TABLE 1

| | |
|---|---|
| 1 | WHO performs the specific task? - Organization, division, role, etc. |
| 2 | WHAT task is to be performed? - Action verb, structure/system/ |
| | component and part, etc. |
| 3 | HOW is the task performed in a safe and efficient manner? - Tool, |
| | material, measurement type, measurement unit, criterion, status, etc. |

The paragraph type classification unit 320 identifies each paragraph into one of predefined paragraph types. The disclosure may identify each paragraph into one of predefined types (for example, 17 paragraph types) classified into three groups.

The first paragraph group includes 5 paragraph types as shown in [Table 2]. Each paragraph belong to the first group includes two components of action verbs(s) and their target object(s), where its specific type is discriminated by the action verb(s) used and the existence of condition component. The second paragraph group may include 8 paragraph types, as shown in [Table 3], where each of them is closely related to a specific action step. The third paragraph group may include 4 paragraph types, as shown in [Table 4], where each of them is not closely related to a specific action step. 12 paragraph types in [Table 3] and [Table 4] may be merged to a group of paragraph types other than action steps.

TABLE 2

| | |
|---|---|
| (non-conditional) action | A (non-conditional) action step typically starts with an action verb, possibly |
| step | preceded by additional component(s) of critical information and/or an |
| | adverb. |
| Branching step (GO TO~ | A special kind of action step that includes one of designated action verbs. |
| or PROCEED TO~) | |
| Referencing step (REFER | |
| TO~, SEE~, USE~, | |
| REPEAT~, or PER) | |
| Conditional action step | A special kind of action step that starts with one of designated keywords. |
| (IF/WHEN<condition(s)>, | The <condition(s)> could be a compound of multiple conditional clauses, |
| THEN<action(s)> | each connected with another one by a logical operator (e.g., AND), or a |
| Continuous action step | list of conditional clauses after the clause including such descriptions as |
| (WHILE/IF AT ANY TIME | ‘any of the following’. The <action(s)> clause is usually in a form of an |
| <condition(s)>, <action(s)> | action step. |

TABLE 3

| | |
|---|---|
| NCW heading | Each statement following NOTE, CAUTION, or WARNING (each to be |
| NCW statement | classified as a NCW heading) is to be classified as an NCW statement. |
| | Each of those shall be placed right before the action step(s) to which it |
| | applies and shall not include any directive. |
| Hold point | The paragraph of ‘HOLD POINT’ or in the form preceded with a topical |
| | keyword, like ‘QA HOLD POINT’. |
| Record row | Paragraphs placed after an action step requiring to record the observed |
| Calculation row | data or the calculated values(s), utilizing a simple formula involving newly |
| | observed data, are classified as a record row or a calculation row, |
| Signoff row | respectively. A signoff could be represented as an independent paragraph |
| | to be classified as a signoff row. |
| Logical operator | In case any logical operator itself builds a paragraph, it is classified as a |
| List element | logical operator. A list element is each paragraph in bullet form listed |
| | typically after an action step including such descriptions like ‘the |
| | following’. |

TABLE 4

| | |
|---|---|
| (sub) section title | (sub) section title; caption of a figure or table. |
| caption of a figure | |
| or table | |
| continuation | A paragraph of expression inserted to denote |
| heading | a page break that a step continues onto another page. |
| Information | A paragraph that is not any of the above types. |

The step component identification unit 330 may identify optional components that provide additional information related with the task described with action verb(s) and their target objects(s) in an action step paragraph. That is, the step component identification unit 330 may identify 4 optional components (condition, critical information/critical location, adverb, supporting information/non-critical location) other than two mandatory components of action verb(s) and their target object(s).

The information extraction module 10 is performed as follows.

Input procedure documents are preprocessed by the preprocessing unit 100. Then, the extended NLP unit 200 applies existing NLP technologies utilizing public NLP tools to the preprocessed text paragraphs. Any misinterpreted NLP results of POS tags and parse trees may be corrected utilizing built-in rules integrated with a lexical database. Next, the information extraction unit 300 performs three types of information extraction, which are semantic element extraction, paragraph type classification, and step component identification.

Meanwhile, the information extraction module 10 may include a database 400 that stores all data processed, including all the significant syntactic and semantic information extracted. The database 400 may deliver the results of the information extraction module 10 to the process model generation module 20. Additionally, the database 400 may also store the results of the process model generation module 20, which are the instantiated BPMN elements and their properties corresponding to each text paragraph of procedures, and the final process models of procedures with the BPMN elements integrated and reconstructed.

Again, referring to FIG. 2, the process model generation module 20 of the disclosure may include a conversion unit 500 that represents each paragraph of procedures into BPMN element(s) and their properties according to the paragraph type; and a generation unit 600 that generates BPMN-based process models of procedures in concise and intuitive form by integrating and reconstructing the instantiated BPMN elements. That is, utilizing all the syntactic and semantic information extracted by the information extraction module 10, that includes semantic elements, paragraph types, and step components, BPMN-based process models of procedures intuitive to all interested parties may be generated.

Utilizing the extracted information, the conversion unit 500 may represent each paragraph of procedures into one or more BPMN elements as individual ones or as associated or attached to individual ones.

Types of procedure paragraphs that are to be represented into individual BPMN elements by the conversion unit 500 and a method thereof will be described. Paragraphs of action step types, which are (non-conditional) action steps, branching steps, referencing steps, conditional action steps, and continuous action steps, are represented into individual BPMN elements of flow objects or sequence flows.

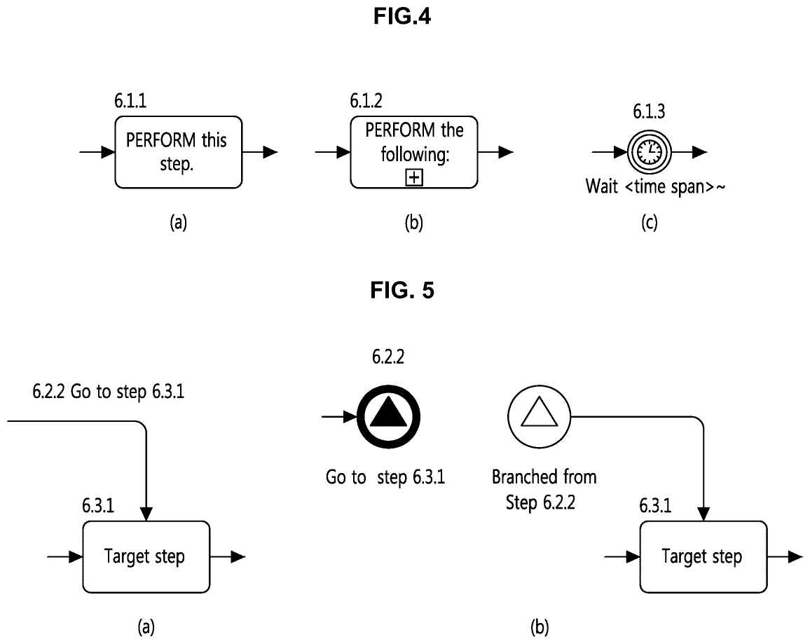

A (non-conditional) action step is a paragraph that may additionally include optional components other than ‘condition’, that is of ‘critical information/critical location’, ‘adverb’, and ‘supporting information/non-critical location’, before or after 2 mandatory components of action verb(s) and their target object(s). Examples of (non-conditional) action steps represented into BPMN elements are illustrated in FIG. 4, as a task activity in FIG. 4(a) and as a subprocess activity in FIG. 4(b). FIG. 4(c) illustrates that a (non-conditional) action step with an action verb that requires waiting for a specific time (for example, ‘wait+<time span>’) is to be represented as a timer event. Step numbers (or bullets) may be marked at upper left corner or on top of the corresponding BPMN elements, as shown in FIG. 4.

A branching step (Go to ˜, Proceed to ˜, etc.) directs to move to another step apart from the current step. It is to be represented as a BPMN sequence flow pointing to the target step (FIG. 5(a)) or alternatively as a pair of BPMN signal events to minimize edge-crossing when visualized (FIG. 5(b)). That is, FIG. 5(a) and FIG. 5(b) are for the same branching step, represented in different ways. Two signal events in FIG. 5(b) are an end event marked with the ‘throw signal’ of a filled-in triangle and a start event marked with the ‘catch signal’ of an empty triangle, respectively.

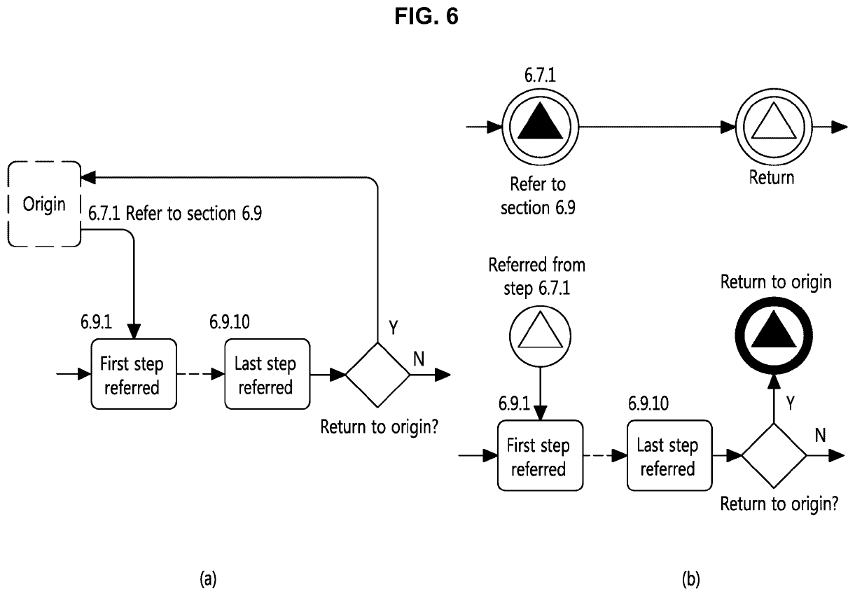

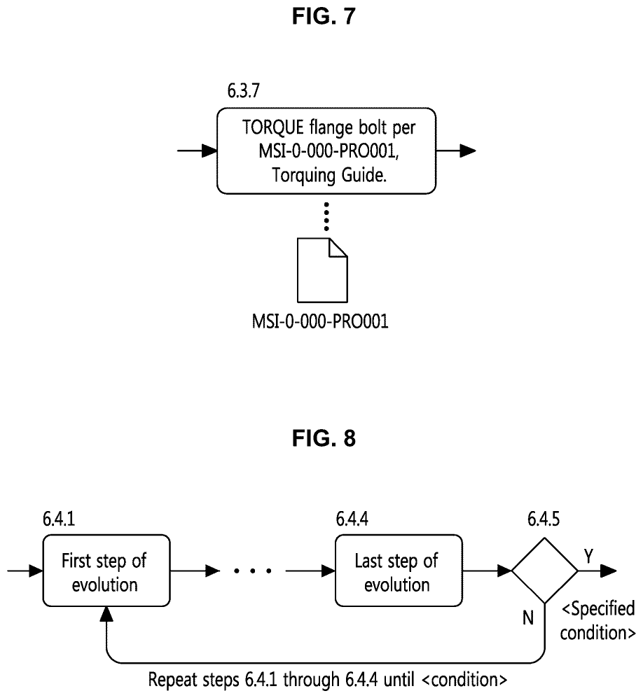

A referencing step (Refer to ˜, See ˜, Use ˜, Repeat ˜, etc.) directs to refer to another step(s) or section(s), within the same or in another procedure, and then to return to the origin. A referencing step is represented similarly to that of a branching step, but with an additional sequence flow or additional pair of signal events after the referred step(s) to ensure its return. An additional exclusive (XOR) split gateway is also introduced to discriminate whether or not to return to the origin (FIG. 6(a)). The dashed activity labeled as ‘Origin’ in FIG. 6(a) is for the step that directs referencing. Another type of referencing with preposition ‘per’ is represented with its target document (or its specific part) as a data object associated with the origin step (FIG. 7).

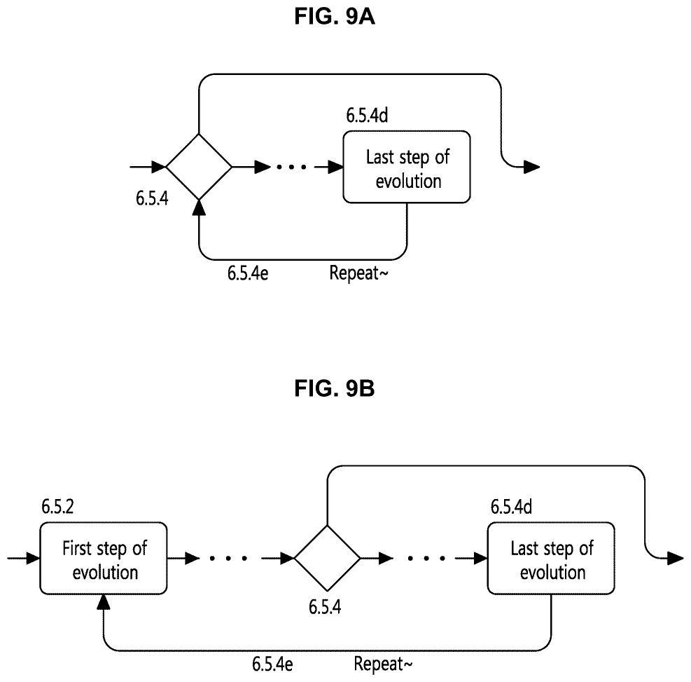

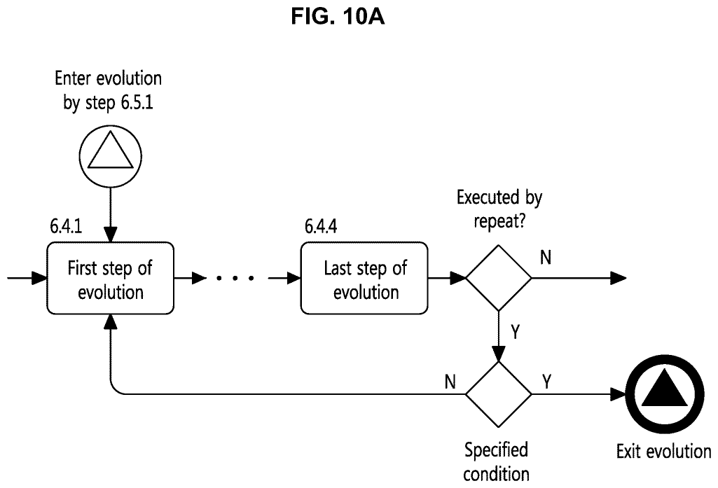

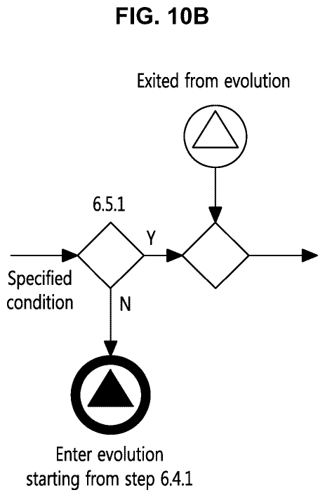

The action verb ‘Repeat’ is used when a series of previously executed steps are to be performed in multiple evolutions until the specified condition is met. FIG. 8 illustrates how a step paragraph with action verb ‘Repeat’ is represented with BPMN elements. It is represented as an exclusive split gateway of the specified condition to discriminate whether to repeat or not, right after the last step of evolution, where one of its outgoing sequence flows directs to the first step of evolution (FIG. 8). This exclusive split gateway should be specified with a clear criterion for exiting the evolution, and it could be alternatively placed right before (FIG. 9A) or in the middle (FIG. 9B) of steps to be repeated. Alternatively, a ‘Repeat’ step could be represented as two pairs of throw and catch events, as illustrated in FIGS. 10A and 10B, which is useful when the evolution steps are apart from the origin. Additional split gateways are introduced at the origin and at the end of the evolution steps, for the proper management of repetition.

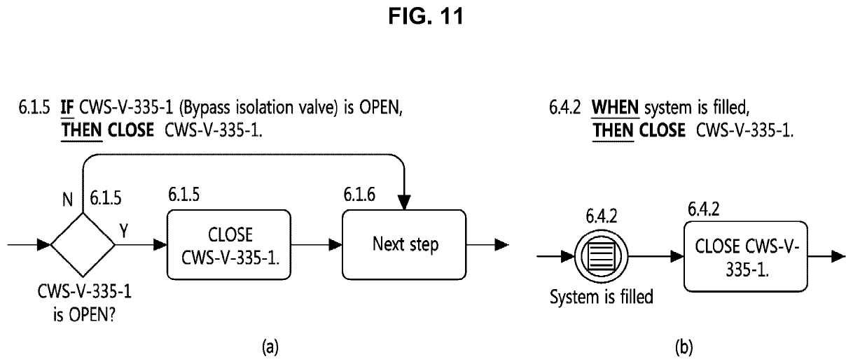

A conditional action step (IF/WHEN <condition(s)>, THEN <action(s)>) starts with one of designated keywords. Its <action(s)> clause is of the form of an action step and is to be performed when its <condition(s)> clause is satisfied. The keyword ‘IF’ is associated with a condition that may or may not be true. Thus, a conditional action step starting with ‘IF’ is represented as a BPMN exclusive split gateway corresponding to <condition(s)>, with branches exclusively pointing the activity corresponding to <action(s)> or another BPMN element(s) corresponding to next step (FIG. 11(a)). On the other hand, the keyword ‘WHEN’ is associated with a condition that is expected to occur. Thus, a conditional action step starting with ‘WHEN’ is represented as a BPMN conditional event, that is triggered if the given condition is evaluated as true, and is followed by the activity corresponding to <action(s)> (FIG. 11(b)).

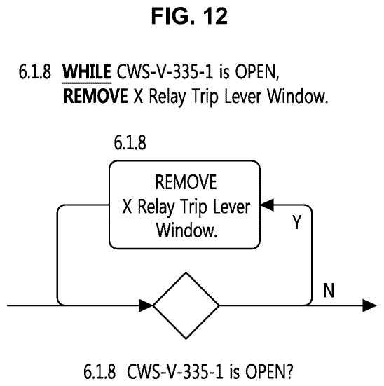

A continuous action step (WHILE/IF AT ANY TIME <condition(s)>, <action(s)>) directs to perform the <action(s)> as long as the <condition(s)> is met. Thus, it is represented as a BPMN activity corresponding to <action(s)> preceded by an exclusive split gateway corresponding to <condition(s)> that either exclusively leads to next step when the <condition(s)> is not met (FIG. 12).

In the above, it has been described with illustrative examples regarding how each of 5 paragraph types belonging to the first group, discriminated by the action verb(s) used and the existence of condition component, is represented with BPMN elements.

Next, other paragraph types that are closely related to a specific action step will be described.

NCW statement(s) following ‘NOTE’, ‘CAUTION’, or ‘WARNING’ (each to be classified as a NCW heading) is to be placed right before the action steps to which they apply and shall not include any directive.

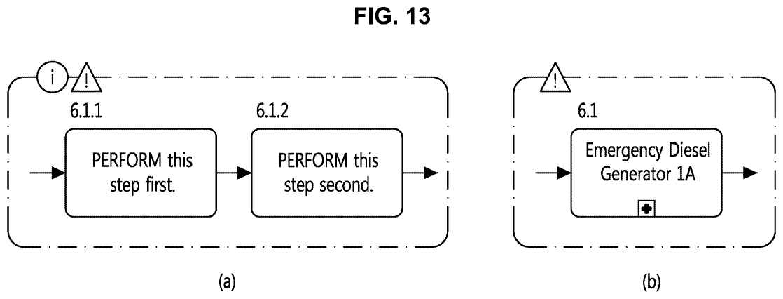

FIG. 13(a) illustrates 2 types of NCW statements (and their NCW headings) applying to 2 consecutive action steps represented in BPMN elements. A BPMN group element, represented as a dot-dashed rounded rectangle, is used to indicate the action step(s) to which the specific NCW statement(s) applies. Distinct marker(s) will be placed on the upper left boundary of such BPMN group elements, for easy discrimination of the corresponding NCW heading type(s). FIG. 13(b) illustrates the representation of NCW statement(s) that is applied to an entire subsection. List(s) of NCW heading types and each corresponding NCW statement(s) are represented as extended properties of the corresponding BPMN group element.

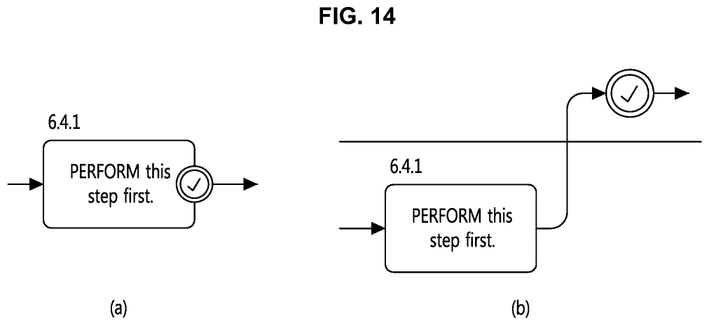

FIG. 14 illustrates representation of signoff rows into BPMN intermediate events, extended to embrace the check mark, in two different ways: (1) as attached to the task with the sequence flow originating from it, in case it is supposed to be verified by the task performer (FIG. 14(a)); or (2) as an individual flow object, connected with sequence flows, in a separate lane designated for another participant that performs the verification (FIG. 14(b)).

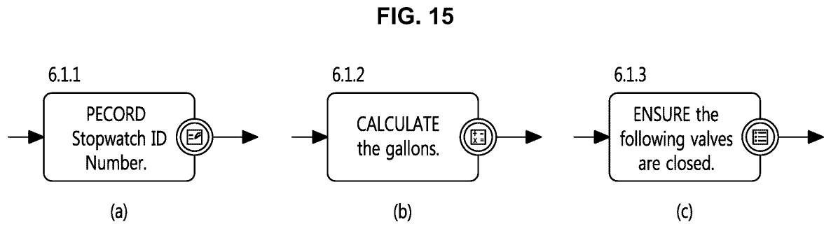

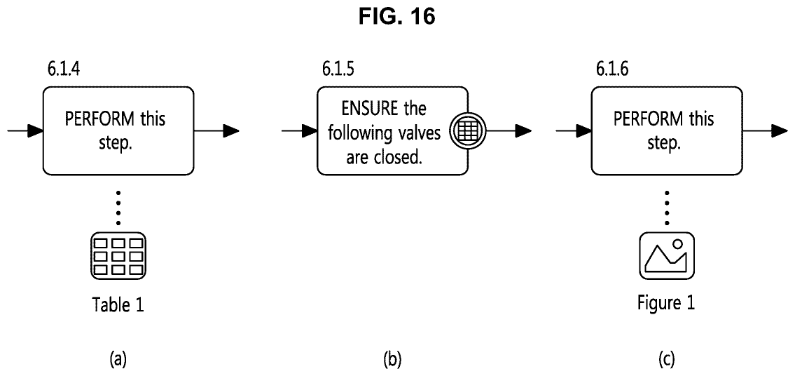

FIG. 15 illustrates representation of a record row, a calculation row, and a set of list elements into BPMN elements, respectively.

A record row or a calculation row follows action step(s) with action verbs of ‘Record’ and/or ‘Calculate’, respectively, and embraces underlined whitespace(s) supposed to be filled-in by the step performer. Each of them will be represented as an extended BPMN event attached to the activity of the corresponding action step(s), each discriminated with a distinct marker, as shown in FIG. 15(a) and FIG. 15(b). A set of sibling paragraphs of list element type is also represented as an extended BPMN event attached to the task node corresponding to their parent action step, embraced with another distinct marker (FIG. 15(c)).

Tables and figures, as non-text objects, are identified and stored separately by the information extraction module 10. Table captions and figure captions are identified as paragraphs of Table/Figure caption type. Tables are classified into two types according to their purposes: (1) a plain table that provides related information in a structured way; or (2) a non-plain table that is used for recording, calculation, or placekeeping.

A plain table is represented as a newly introduced BPMN artifact, the table object, associated with the corresponding activity (FIG. 16(a)). A non-plain table is represented as a newly introduced BPMN event, the table event, attached to the task requiring to fill it up (FIG. 16(b)). A figure used to provide supplementary information for action step(s) is represented similarly to the plain table with a newly introduced BPMN artifact, the figure object (FIG. 16(c)).

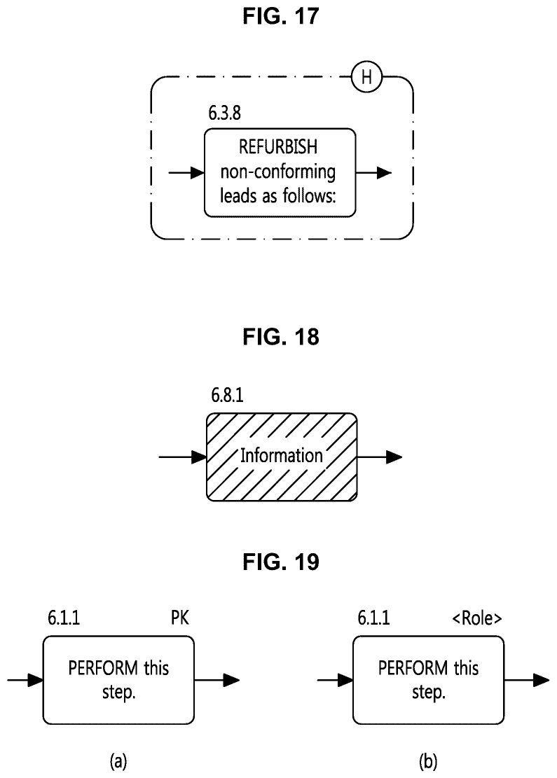

A hold point indicates a pre-selected step in a procedure beyond which work may not proceed until the required action is performed. In general, it is requested that a designated staff member verifies completion of predefined steps. A hold point paragraph is also represented as a BPMN group element embracing those steps that need to be attended by the designated staff member, with a newly introduced marker attached to its upper right boundary (FIG. 17).

A paragraph of the information type is primarily an improperly written action step or NCW statement, which should be reviewed carefully and rewritten according to its intended purpose and then to be properly represented in the process model. It will be temporarily represented as a shaded activity to emphasize that its clarification is required (FIG. 18).

Some paragraphs could be associated with a placekeeping that is used to track execution of procedure steps. Each placekeeping is represented as an extended property of the corresponding activity and is marked at its upper right corner as shown in FIG. 19. According to the procedure participant who performs the placekeeping, distinct markers are used, as ‘PK’ for the main procedure performer or the specific <Role> of another participant.

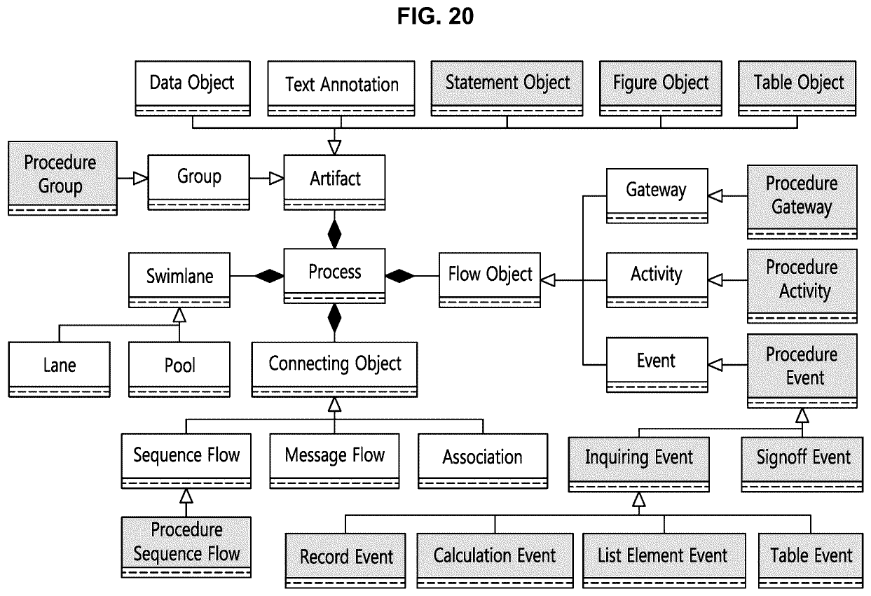

FIG. 20 summarizes the BPMN meta-model extension according to the disclosure to represent all significant syntactic and semantic information extracted from procedures. Newly extended classes, which are ‘Procedure Group’, ‘Statement object’, ‘Figure object’, ‘Table object’, ‘Procedure gateway’, ‘Procedure activity’, ‘Procedure event’, ‘Inquiring event’, ‘Signoff event’, ‘Table event’, ‘List element event’, ‘Calculation event’, ‘Record event’, ‘Procedure sequence flow’, are represented by rectangles with dark backgrounds while the others are standard BPMN classes. Those classes are instantiated to represent paragraphs of procedures into BPMN elements. All BPMN elements and their properties instantiated by the conversion unit 500 to represent corresponding paragraphs of procedures are stored to the database 400.

The disclosure may integrate and reconstruct the BPMN elements, instantiated to represent each paragraph of a procedure as described above, to generate the final BPMN-based process model for each procedure.

The generation unit 600 of the process model generation module 20 builds BPMN-based process models of procedures utilizing BPMN elements and their properties instantiated to represent each procedure paragraph and stored to the database 400 by the conversion unit 500. Each procedure is represented as an independent BPMN process model in a swimlane of a pool divided into as many lanes as the number of participating staffs performing the procedure. All flow objects (and their associated or attached BPMN elements) to be performed by a participating staff are represented in the corresponding lane. A start event or an end event is additionally introduced to precede or succeed a flow object that has no predecessor or no successor, respectively.

To generate the final BPMN-based process model for a procedure, BPMN elements instantiated to represent each paragraph of the procedure are integrated and reconstructed. Individual BPMN elements are first integrated by connecting each pair of them with a sequence flow based on their precedence, split, or referencing relation; and then the integrated BPMN-based process model of the procedure is reconstructed to be more concise and intuitive by decomposing or combining the instantiated BPMN elements.

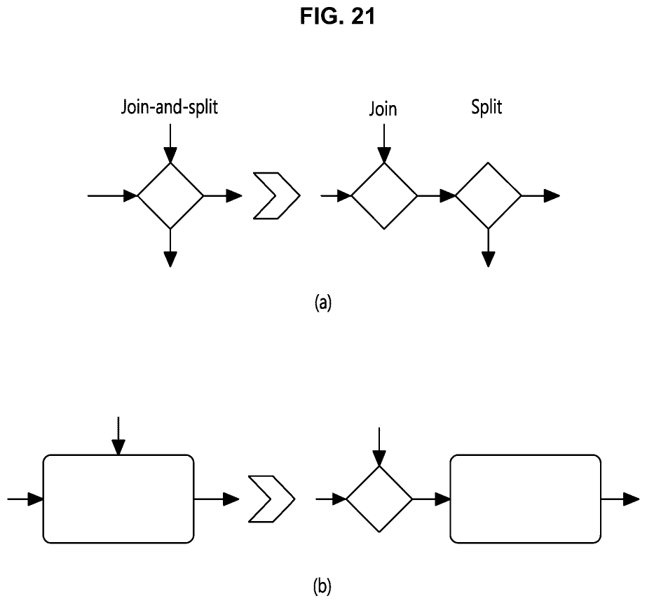

First, refinements of BPMN gateways are required for the clarification of control flows in a process model. Each gateway in BPMN is required to be a split or a join, but cannot be both. Each join-and-split gateway is separated into a join gateway followed by a split gateway of the same control type (FIG. 21(a)). For an activity merging multiple sequence flows, an exclusive join gateway is additionally introduced to merge those sequence flows and to lead to that activity (FIG. 21(b)).

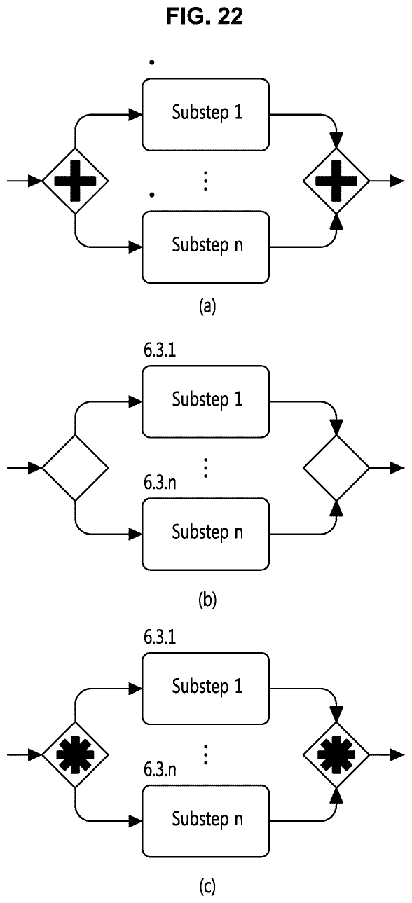

In addition, three types of block structures depicted in FIG. 22 may be utilized to reconstruct a BPMN-based process model to make it more concise and intuitive.

Non-alphanumeric bulleted, such as ‘.’, sub-steps of sibling relations may be performed in any order, where all of them must be completed before proceeding to the next step of their parent step. The task elements of sibling bulleted sub-steps are merged into a parallel block structure that requires completion of all branches regardless of their execution orders (FIG. 22(a)). If only one of sibling sub-steps is to be selected and executed, for example by a phrase of ‘one of the following’, they are merged into an exclusive block structure that requires completion of only one of those branches (FIG. 22(b)). A complex block structure could be used for more complicated cases (FIG. 22(c)).

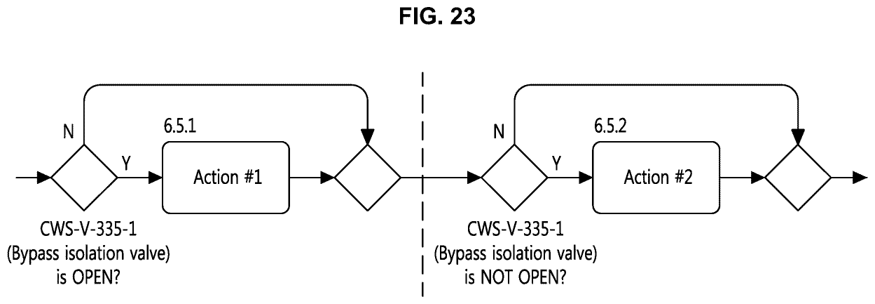

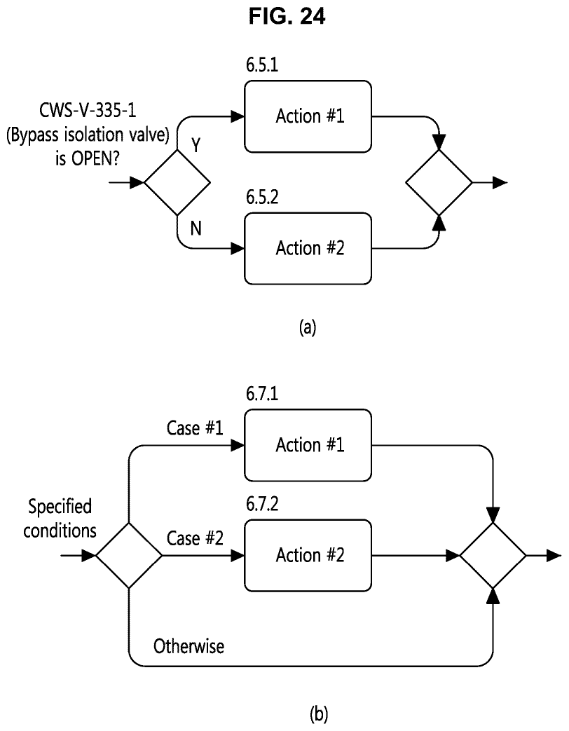

Two consecutive conditional action steps both starting with ‘IF’, when their <condition(s)> are exclusive as depicted in FIG. 23, are merged into a single exclusive block with each branch designated with corresponding action(s) (FIG. 24(a)). If those branches are not complete for the specified condition, another branch labeled as ‘otherwise’ without any designated activity is introduced to provide a bypass for this exclusive block structure (FIG. 24(b)).

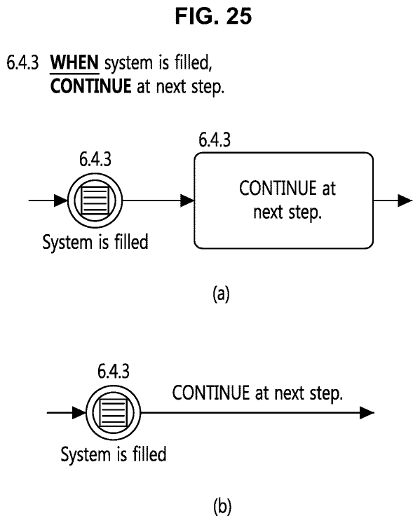

As another example, FIG. 25(a) shows a continuous action step where its action clause only implies continuing to the next step. Such task element requiring no specific action could be removed and labeled on the sequence flow to the next step (FIG. 25(b)).

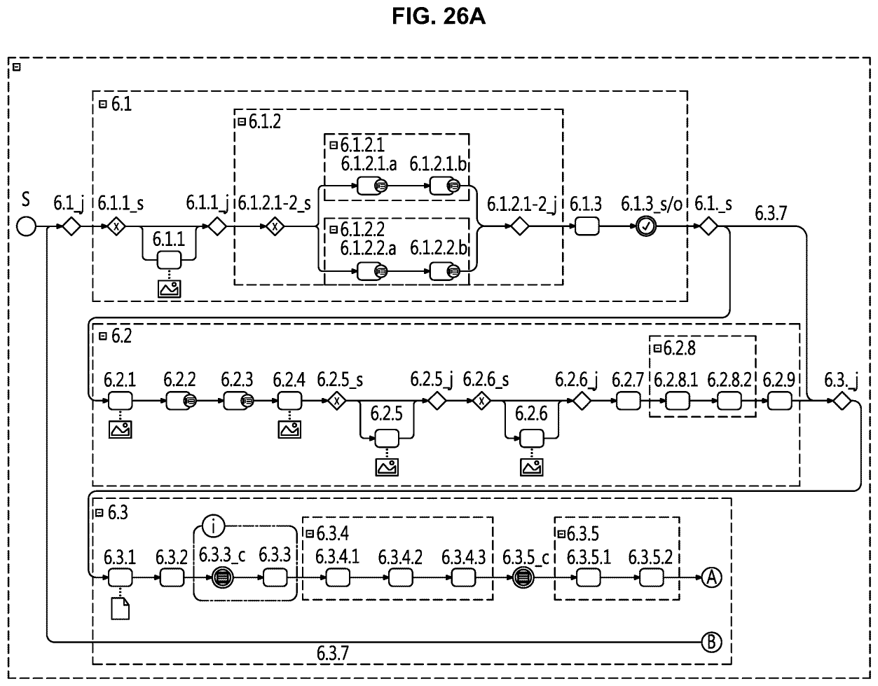

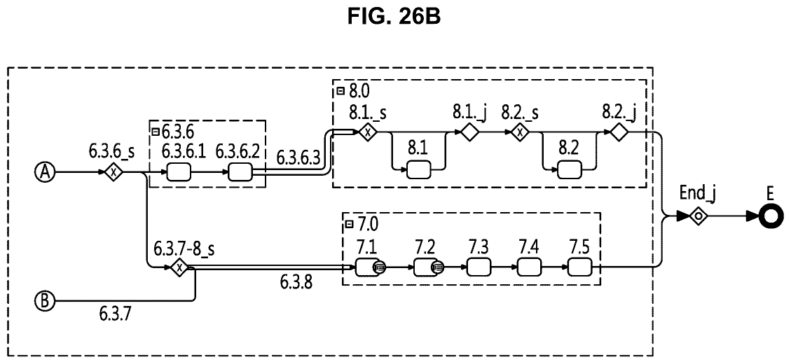

FIG. 26A and FIG. 26B show an example extended BPMN diagram of the process model, automatically built according to the disclosure, for 3 selected sections of a sample NPP procedure. Each dashed rectangle represents a subprocess, for a (sub) section or a simple block structure, where a small square at upper left corner marked with ‘−’ indicates that the subprocess activity is expanded to show its internal structure. As shown in FIG. 26A and FIG. 26B, this process model has 5 top layer subprocesses, of (sub) sections 6.1, 6.2, 6.3, 7.0, and 8.0. A sequence flow for referencing or branching may be represented in different styles for their easy discrimination, for example single stringed for referencing and double stringed for branching. An exclusive block structure shown in the top row is for the step requiring to select and execute only one of its sub-steps, by the expression of ‘one of the following’, as described above. It is shown that 6 task activities are associated with a figure or a document (or its part). Each of three intermediate events is either for a signoff or for a condition component starting with ‘WHEN’. It is also shown that many activities have attached elements. For each exclusive join gateway, mark ‘X’ is omitted for easy discrimination from exclusive split gateways. Lanes for participating staffs and labels for BPMN elements are also omitted for simplicity.

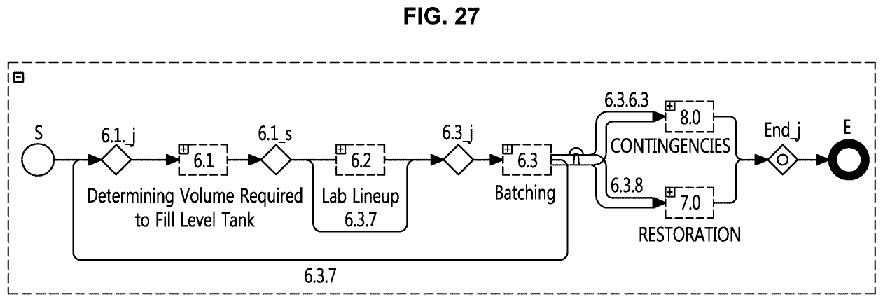

FIG. 27 illustrates a reduced version of the diagram of FIG. 26A and FIG. 26B, with top layer 5 subprocesses, of subsections 6.1, 6.2, 6.3, 7.0, and 8.0, are abstracted each into a single activity node. When clicked a small square marked with ‘−’ at the top left corner, as shown in FIG. 26A and FIG. 26B, the corresponding dashed rectangle of a subprocess, of a subsection or a block structure, reduces to a single activity node with the mark changed to ‘+’, as shown in FIG. 27. Reversely, when clicked a small square marked with ‘+’ of a node in FIG. 27, that activity node is expanded to show its internal structure as in FIG. 26A and FIG. 26B. That is, embodiments of the disclosure allows users to understand an entire process model, especially for a large one, being capable of expanding or reducing any specific parts according to their interests.

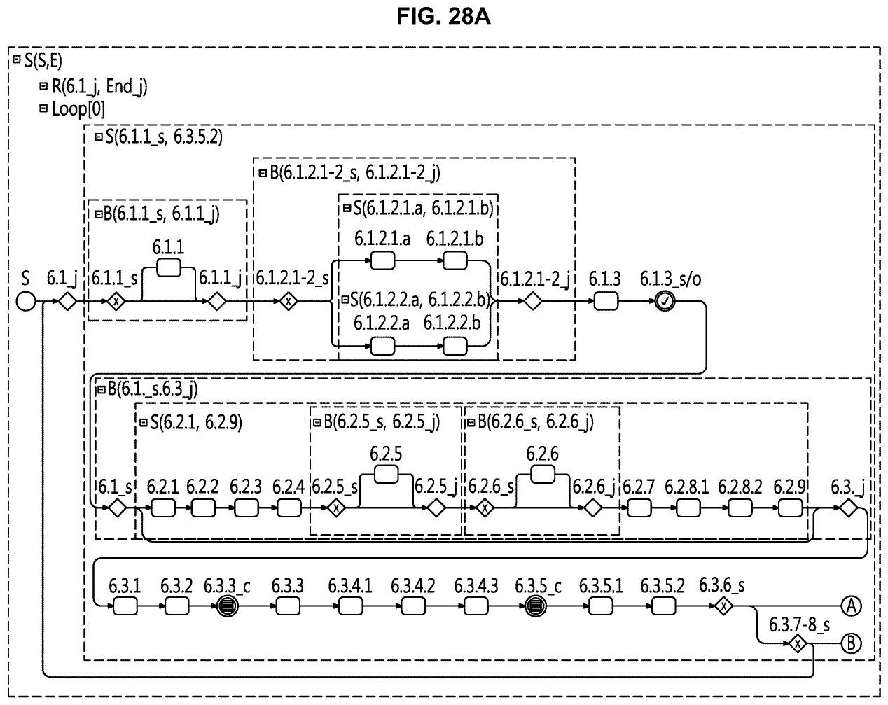

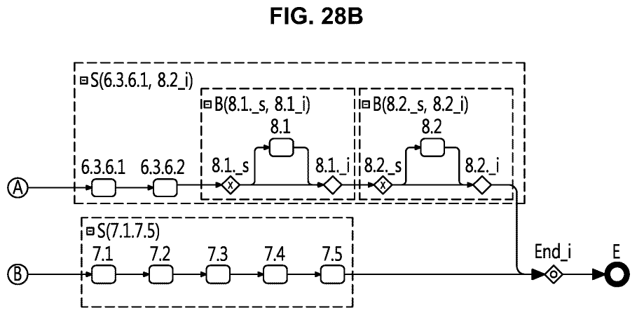

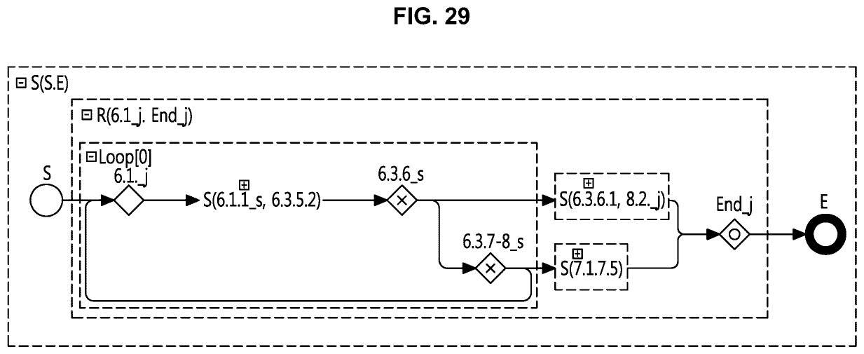

Additional diagrams in FIGS. 28A, 28B, and 29 illustrate that various analysis may be applied easily for a process model. Each dashed rectangle in FIG. 28A and FIG. 28B now represents a loop or a single-entry single-exit (SESE) structure found from the process model. For example, the internal structure of a dashed rectangle labeled as ‘Loop [0]’ is a loop structure found. A loop structure makes it complicated to analyze a process model, thus it is critical to figure out existence of loops and their scope. On the other hand, each SESE structure is connected to an external structure only via its unique entry and/or its unique exit, thus could be analyzed independently. Each SESE structure is much smaller and simpler compared with the entire process model. Therefore, a process model could be analyzed much more efficiently through a divide-and-conquer approach. FIG. 29 illustrates a reduced version of the process model in FIG. 28A and FIG. 28B, showing only the top layer structures. It is shown that the internal structure of subsection 6.3 are dispersedly included both in a loop structure having two loop exits and a SESE structure, and connected to another SESE structure. Thus, it infers that more careful analysis is required for subsection 6.3 (and subsection 6, further).

### MODE FOR CARRYING OUT THE INVENTION

Next, application results of the disclosure are described, illustrated with summary analysis results for 25 procedures of a commercial NPP in United States, 10 operating procedures (OPs) and 15 testing procedures (TPs).

Table 5 below summarizes the frequencies of branching and referencing by their types found from the 25 procedures.

TABLE 5

| | OP | | | | | TP | | | | |
|---|---|---|---|---|---|---|---|---|---|---|
| Type of branching (B) | CC starting with | | | | | CC starting with | | | | |
| or referencing (R) | N/A | If~ | When~ | While~ | Sum | N/A | If~ | When~ | While~ | Sum |
| B only | 6 | 13 | 15 | — | 34 | — | — | 3 | — | 3 |
| B Another action + B | 2 | 5 | — | — | 7 | — | 1 | — | — | 1 |
| Subtotal | 8 | 18 | 15 | — | 41 | — | 1 | 3 | — | 4 |
| R only | 56 | 25 | 7 | — | 88 | 10 | 1 | — | — | 11 |
| Another action + R | 8 | — | — | — | 8 | 6 | — | — | — | 6 |
| R by an action verb | | | | | | | | | | |
| Another action + R | 170 | 102 | 11 | — | 283 | 27 | 6 | — | 1 | 34 |
| by the preposition ‘per’ | | | | | | | | | | |
| Subtotal | 234 | 127 | 18 | — | 379 | 43 | 7 | — | 1 | 51 |
| Total | 242 | 145 | 33 | — | 420 | 43 | 7 | 3 | 1 | 55 |

CC: condition component

Referring to Table 5, branching and referencing were found more often in OPs than TPs. In addition, many branching or referencing were found in action clauses of conditional action steps starting with ‘IF ˜’ or ‘WHEN ˜’ other than in non-conditional action steps. Referencing with a phrase or clause starting with ‘per’ is found most frequent.

To where referencing are directed are summarized in Table 6 for referencing by an action verb and in Table 7 for referencing by the preposition ‘per’. From Table 6 and Table 7, it is shown that referencing are directed more often to the same procedure of the origin than to other procedures or documents.

TABLE 6

| Action verb | CC | OP | | | TP | | |
|---|---|---|---|---|---|---|---|
| used for | starting | Same | Other | | Same | Other | |
| referencing | with | procedure | procedure | Sum | procedure | procedure | Sum |
| Other than | N/A | 28 | 16 | 44 | 7 | — | 7 |
| ‘Repeat’ | If~ | 13 | 5 | 18 | 1 | — | 1 |
| | When~ | 7 | — | 7 | — | — | — |
| | Subtotal | 48 | 21 | 69 | 8 | — | 8 |
| ‘Repeat’ | N/A | 20 | — | 20 | 9 | — | 9 |
| | If~ | 7 | — | 7 | — | — | — |
| | Subtotal | 27 | — | 27 | 9 | — | 9 |

| | | | | | | |
|---|---|---|---|---|---|---|
| Total | 75 | 21 | 96 | 17 | — | 17 |

CC: condition component

TABLE 7

| | OP | | | | TP | | | |
|---|---|---|---|---|---|---|---|---|
| CC starting | Same | Other | Other | | Same | Other | Other | |
| with | procedure | procedure | document | Sum | procedure | procedure | document | Sum |
| N/A | 114 | 55 | 1 | 170 | 9 | 17 | 1 | 27 |
| If~ | 87 | 15 | — | 102 | 3 | 3 | — | 6 |
| When~ | 8 | 3 | — | 11 | — | — | — | — |
| While~ | — | — | — | — | — | 1 | — | 1 |
| Total | 209 | 73 | 1 | 283 | 12 | 21 | 1 | 34 |

CC: condition component

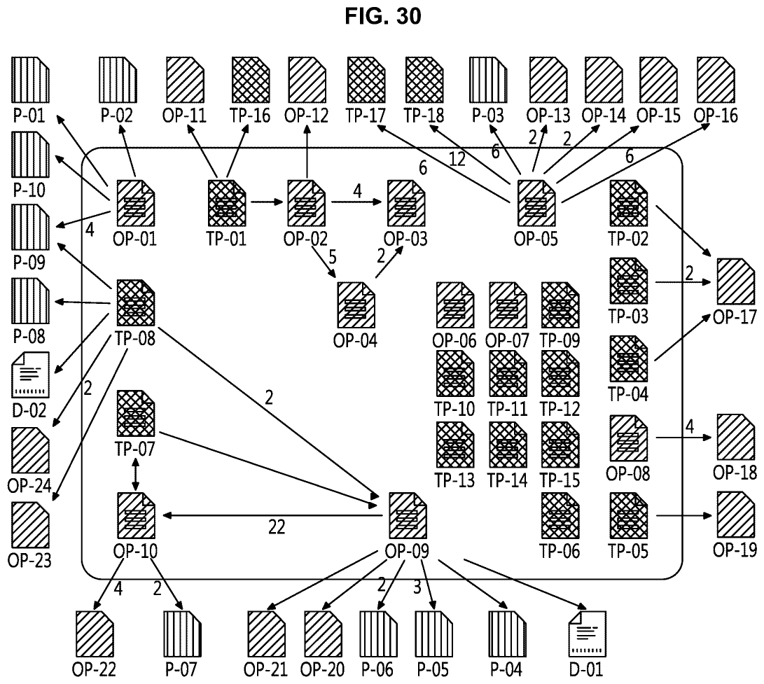

FIG. 30 summarizes all referencing relations found from the 25 procedures. In FIG. 30, symbols representing procedures or other documents are in distinct stripe patterns according to their types: inclined for OPs, cross-inclined for TPs, vertical for procedures of other categories than operating or testing, and none for other types of documents. The twenty-five procedures analyzed are represented inside the large rounded rectangle, where other procedures and other types of documents referenced by the 25 procedures are represented outside of it. Each directed edge indicates that its source document refers to its target document. The number on each directed edge represents the referencing count from its source document to its target document, where each unlabeled one is a single incidence of referencing. To preserve the confidentiality of facility-specific information, all the document codes were arbitrarily assessed in series for each document type.

As described above, the disclosure may represent each paragraph of a procedure into one or more BPMN element(s) and their properties, and then provides the final BPMN-based process model of the procedure through integrating and reconstructing the instantiated BPMN elements, to enable all interested parties to intuitively understand various procedures required to run a plant safely and to easily conduct further additional analysis of procedures.

Meanwhile, in accordance with one or more embodiments of the disclosure, a method can be included as a program command performed through various computer means and recorded in a computer reading medium. The computer reading medium may include a program command, data file, data structure, etc., or a combination of them. The program command recorded in the medium can be designed and configured specifically for the disclosure, or it can be set up to notify an operator of computer software as a usable command. Examples of the computer reading medium may include magnetic media such as a hard drive or magnetic disk, an optical medium such as CD-ROM and DVD, a magneto-optical media such as a floptical disk, and a hardware device such as ROM, RAM, and flash memory that is specifically configured to save and perform a program command. Examples of the program command may include not only a machine language code made by a compiler, but also a high-level language code that may be executed by a computer using an interpreter, etc. These hardware devices may be configured so as to be operated as one or more software modules to perform an operation in the disclosure; a reversed situation may also be possible.

The above-described exemplary embodiments are examples from the disclosure, but the disclosure is not limited to those aspects only. The disclosure can be customized in various forms by those skilled in the art so that the technical scope of the disclosure should be defined by the following claims.

### INDUSTRIAL APPLICABILITY

The disclosure may be utilized for methods and systems for the advanced management of a large volume of procedures of various categories, which play a key role for the safe operation of an industrial plant with large facilities—such as a power plant, an oil refinery, a (petro) chemical plant, a desalination plant, etc.—enabling all interested parties to intuitively understand the details and facilitating further analysis of them for continuous improvement.

What is claimed is:

1. A method to generate process models of plant procedures, comprising:
performing an information extraction stage that extracts all significant syntactic and semantic information from procedures; and
performing a process model generation stage that generates process models of the procedures utilizing the syntactic and semantic information extracted,
wherein the information extraction stage and the process model generation stage are performed sequentially.

2. The method of claim 1,
wherein the information extraction stage comprises,
a first stage that preprocesses input procedure documents;
a second stage that applies existing NLP technologies to text paragraphs returned from the first stage and corrects any misinterpreted NLP results of POS tags and parse trees of tokens; and
a third stage that performs semantic element extraction, paragraph type classification, and action step component identification for each text paragraph of procedures utilizing the results of the first and the second stages.

3. The method of claim 2,
wherein to detect and correct the misinterpreted NLP results of POS tags and parse trees of tokens at the second stage, pattern-based built-in rules integrated with a lexical database are utilized.

4. The method of claim 2,
wherein the semantic element extraction at the third stage is performed in combined manner, by looking up instances of words included in a predefined ontology each associated with a semantic type; and by pattern-based built-in rules described with POS tags, syntactic tags and elements, pre-found semantic tags and elements, and the resulting semantic types.

5. The method of claim 2,
wherein the paragraph type classification at the third stage comprises identifying each paragraph into one of predefined types classified into three groups, a first group of action step types each including two components of action verb(s) and target object(s), a second group of types each relatively more relevant to an action step than types belong to a third group, and a third group of types each relatively less relevant to an action step than the types belong to a second group.

6. The method of claim 2,
wherein the step component identification at the third stage comprises detecting multiple optional components for each paragraph of an action step type, other than two components of action verb(s) and target object(s), utilizing POS tags, semantic element tags, and parse tree tags according to hierarchical structuring of tokens.

7. The method of claim 1,
wherein the process model generation stage comprises,
a sub-stage of representing each paragraph of the procedures into one or more BPMN elements and their properties utilizing the syntactic and semantic information extracted; and
a sub-stage of generating final BPMN-based process models of procedures by integrating and reconstructing the BPMN elements.

8. The method of claim 7,
wherein for each paragraph classified into the first group of action step types, the paragraph itself or its action clause is represented into individual BPMN element of activities, events or sequence flows,
wherein its conditional clause is represented into individual BPMN elements of gateways or events, and
wherein for each paragraph classified into the second or the third group is represented into BPMN element that is associated or attached to the individual BPMN element instantiated for a paragraph classified into the first group of action step types.

9. The method of claim 7, further comprising:
integrating the individual BPMN elements instantiated for paragraphs of action step types by connecting each pair of them with a sequence flow based on their precedence, split, or referencing relation; and
reconstructing, after the integration, the integrated BPMN-based process models of procedures by decomposing or combining the BPMN elements.

10. A system to generate process models of plant procedures, comprising:
an information extraction module that extracts all significant syntactic and semantic information from procedures; and
a process model generation module that generates process models of procedures utilizing the syntactic and semantic information extracted by the information extraction module.

11. The system of claim 10,
wherein the information extraction module comprises,
a preprocessing unit comprising a non-text processing unit that separates out images and tables in input procedure documents and a text processing unit that extracts structural properties and rich text features for each text paragraph of input procedure documents;
an extended natural language processing (NLP) unit that applies existing NLP technologies utilizing public NLP tools for each text paragraph returned from the preprocessing unit and corrects any misinterpreted NLP results; and
an information extraction unit that extracts all significant syntactic and semantic information, which includes semantic elements, paragraph types, and step components, for each text paragraph utilizing preprocessing and extended NLP results.

12. The system of claim 11,
wherein the extended NLP unit comprises,
a first NLP unit for tokenization, sentence splitting, and lemmatization;
a second NLP unit for part-of-speech (POS) tagging for each token and hierarchical structuring of tokens for each sentence; and
a third NLP unit that detects and corrects any misinterpreted NLP results from outputs of the second NLP unit, utilizing pattern-based built-in rules integrated with a lexical database.

13. The system of claim 11,
wherein the information extraction unit comprises,
a semantic element extraction unit that identifies any significant word(s) of token(s) each to be tagged with one of predefined types utilizing ontology lookup and pattern-based built-in rules;
a paragraph type classification unit that identifies each paragraph into one of predefined paragraph types classified into three groups, a first group of action step types each including two components of action verb(s) and target object(s), a second group of types each relatively more relevant to an action step than the types belong to a third group, and a third group of types each relatively less relevant to an action step than the types belong to a second group; and
a step component identification unit that detects multiple optional components for each paragraph of an action step type, other than two components of action verb(s) and target object(s), utilizing POS tags, semantic element tags, and parse tree tags according to hierarchical structuring of tokens.

14. The system of claim 10,
wherein the process model generation module comprises,
a conversion unit that represents each paragraph of the procedures into one or more BPMN elements and their properties utilizing the syntactic and semantic information extracted; and
a generation unit that provides final BPMN-based process models of procedures by integrating and reconstructing the BPMN elements.

15. The system of claim 14,
wherein the conversion unit represents some of procedure paragraphs into individual BPMN elements of flow objects or sequence flows and represents rest of procedure paragraphs into BPMN elements that are associated or attached to the individual BPMN elements.

16. The system of claim 14,
wherein the generation unit integrates individual BPMN elements, instantiated for procedure paragraphs, by connecting each pair of them with a sequence flow based on their precedence, split, or referencing relation; and then reconstructs the integrated BPMN process models of procedures by decomposing or combining the BPMN elements.
